(19) United States
(12) Patent Application Publication
(10) Pub. No.: US 2008/0223639 A1
(43) Pub. Date: Sep. 18, 2008

(54) Snowmobile with externally mounted radiator

(76) Inventor: Roland Barksdale, Menifee, CA (US)

Correspondence Address: Vern Schooley;Fulwider Patton LLP, Suite 1550, 200 Oceangate, Long Beach, CA, 90802, US

(21) Appl. No.: 11/717,368

(22) Filed: Mar. 13, 2007

(51) Int. Cl. B60K 11/04

(52) U.S. Cl. 180/68.4

(57) ABSTRACT

A snowmobile incorporating a radiator system externally of the engine compartment. The radiator may be disposed within the snowmobile airstream including placement to the rear of the snowmobile chassis. Various peripheral items such as a seat, a luggage rack, and a saddle mount may incorporate the radiator mounting within their respective structures. The radiator may be coupled with various other heat exchange aids such as fans, ducting and a plenum chamber for guiding cooling air toward the radiator and drawing heated air away. Coolant lines are included in a circulatory configuration between the radiator and an internal combustion engine disposed in the snowmobile engine compartment for circulating a coolant fluid therebetween.

### BACKGROUND OF THE INVENTION

The outdoor sports enthusiasts avail themselves of a broad array of recreational activities. Areas receiving increased participation are winter sports where the allure of playing in the snow draws children and adults alike. With a broad assortment of vehicles to choose from, the winter sports enthusiast increasingly demands equipment that can move him faster and help him or her play harder. This pervasive attitude has been stymied by the limitations of most sports equipment in the grueling and adverse conditions associated with performing over soft powdery snow, in frozen ice and unstable ground. One particular piece of winter sports equipment that underperforms in the snow is the snowmobile.

The winter recreationalist is drawn to the snowmobile because of the power and freedom accessible with a motor driven vehicle. Similar to race car drivers or all terrain vehicle (ATV) operators, snowmobile riders seek the speed, mobility, and distances that only an engine driven vehicle can provide in an off-road setting. Unfortunately, the demands and rigors imposed on such vehicles takes its toll from the machinery. Akin to other internal combustion engine vehicles, snowmobiles suffer from overheating in the engine and complexities in cooling the system.

The performance of snowmobiles is often restricted because of overheating in the engine compartment. Since snow has a relatively low frictional coefficient, the driving force generated by a snowmobile engine to run the tracks in traction with the snow is relatively high. Yet snowmobiles, for practical purposes, must use relatively compact engines, transmissions, and cooling systems all sized to fit within a compact engine compartment. The result of confining the heavily worked engine within the compartment near the cooling system is an engine that is inefficiently cooled, underpowered and frequently overheats, the effect of which is a stalled or shutdown snowmobile.

As recognized by those skilled in the art, a snowmobile designed to be driven to locations remote from civilization and prone to overheating can create serious problems. Beyond just the inconvenience it will be recognized that an inoperable snowmobile may well strand the operator some distance from help or shelter, stuck in the freezing cold until the snowmobile engine cools down rendering it operable again.

For others, periodic engine overheating is also a drawback that detracts from the pleasure of the snowmobile riding experience. The snowmobile operator seeking the pleasure of navigating over snowfields with his or her friends finds little pleasure in being left behind to wait for the temperature indicator light to turn off when his overheated engine cools down. The time spent suffering through stalling engines, anemic performance, and downtime while manually cooling off the engine detracts significantly from the pleasure of snowmobiling.

Snowmobile engines in the past have employed air cooled engines. Efforts to improve cooling concentrated primarily on using liquid cooled heat exchangers. These systems often used large water tanks in which engine coolant passes through. These tanks relied on snow being catapulted from the spinning track of the moving snowmobile into the tank. Unfortunately, when the snow is packed or conversely, non-existent, the liquid passing through the tank exchanges little or no heat. When snow is available, its fleeting presence is insufficient to perform the task of cooling the liquid for any appreciable period of time. Their implementation has been largely ineffective in withdrawing heat from the engine and compartment at a sufficient rate to avoid overheating.

Other efforts led to incorporating radiator systems into the engine compartment to provide for liquid heat exchange. Placement of the radiators within the engine compartment and exposed to the oncoming airstream led to issues involving convenient heat exhaust and clogging of the radiator. Snow and debris flowing into the airstream path to the snowmobile often enters the air passage of the radiator core obstructing airflow and limiting the transfer of heat transferred to the air. Furthermore, placement of the radiator proximate the engine allows for heat to be conducted from the engine directly to the radiator, thereby diminishing the capacity of the radiator to cool the engine. The result was a snowmobile with low engine power and high heat generation frequently stopping from engine overheating.

One attempt to solve the problem proposed placing a radiator within the engine compartment. A device of this type is shown in U.S. Pat. No. 5,124,473 to Boyer. A device of this type suffers from the shortcoming of exhausting the hot air out of the engine compartment and into direct contact with the operator.

In some of my work I have also proposed incorporating a radiator in the engine compartment. I have found that arrangement effective for high capacity heat removal. My prior art device is shown at www.coolsled.com.

It can be seen then that a need exists for a more reliable and efficient snowmobile cooling system capable of preventing frequent overheating while exhausting heat away from the rider, unless desired.

### SUMMARY OF THE INVENTION

Briefly and in general terms, the snowmobile of the present invention includes a chassis, a seating apparatus, a forwardly disposed engine compartment, internal combustion engine, a radiator mounted external of and spaced from the engine compartment, coolant lines and a coolant pump for circulating coolant from the engine back to the radiator.

One embodiment uses a standard snowmobile chassis incorporating an internal combustion engine mounted within the engine compartment. The radiator is spaced outside the engine compartment and out of direct heat exchange. Coolant lines couple the internal convective engine through the chassis and chassis exterior with the radiator for circulating a coolant there between. Thus, the ambient air in the space external to the engine compartment acts as a thermal barrier to heat transfer from the engine to the body of the radiator. A fluid pump (usually powered by the engine) circulates the engine coolant liquid through the heat exchangers and back to the engine.

In another embodiment, the snowmobile may also include a plenum chamber or chambers, and one or more fans situated so as to send air to or pull air from the radiator media. The fans may be mounted directly to the radiator, or in a different location communicating with the radiator via ducting that may be constructed of flexible, rigid, or semi-rigid materials. The fan or fans may be electrically powered and in connection with the electrical system of the snowmobile or may incorporate a separate power source charged by the vehicle electrical system or in some cases, be self-sustained through a solar cell. The plenum chamber may include a heat absorptive element disposed within the snowmobile's airflow path where the air flow is chilled before contacting the radiator. In another embodiment of the system, the radiator may include two radiator cores configured in an acute angle to one another with the fans and plenum chamber disposed in the same operative manner where a single radiator core is used.

In yet another embodiment, the snowmobile includes a seat centrally disposed on the chassis with the chassis continuing to extend rearwardly of the seat defining a tail section. The seat may include a hollow storage compartment underneath its seat pad, a saddle bag mount mounted next to the seat or a utility rack mounted to the rear of the seat. In either of these configurations the radiator may be mounted either on the chassis in the open area behind the seat, within the hollow seat compartment itself, or onto any utility racks or saddle bag mounts present.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a side view of a snowmobile embodying the present invention;

FIG. 2 is a top view of the snowmobile shown in FIG. 1;

FIG. 2A is a functional diagram of a cooling system used in snowmobile of FIG. 1;

FIG. 3 is a side view of a second embodiment of the present invention;

FIG. 4 is a top view of the snowmobile shown in FIG. 3;

FIG. 5 is a schematic of a radiator system which may be incorporated in a third embodiment of the snowmobile shown in FIG. 1;

FIG. 6 is a schematic of another radiator system that may be incorporated in a fourth embodiment of the snowmobile shown in FIG. 1;

FIG. 7 is a side view of a fifth embodiment of the snowmobile of the present invention;

FIG. 8 is a top view of the snowmobile shown in FIG. 7;

FIG. 9 is a partial side view of a sixth embodiment of the present invention;

FIG. 10 is a top view of the snowmobile shown in FIG. 9;

FIG. 11 is a tip view of a seventh embodiment of the present invention; and

FIG. 12 is a partial top view of an eighth embodiment of the present invention.

### DETAILED DESCRIPTION OF THE PREFERRED EMBODIMENTS

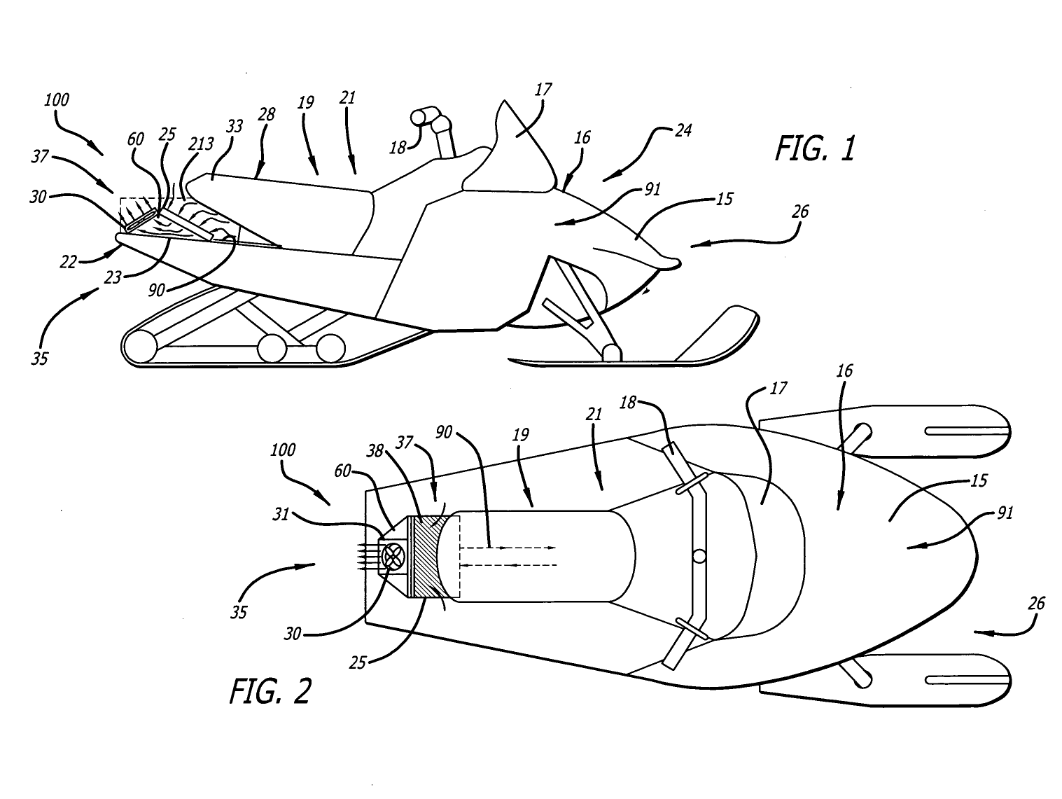

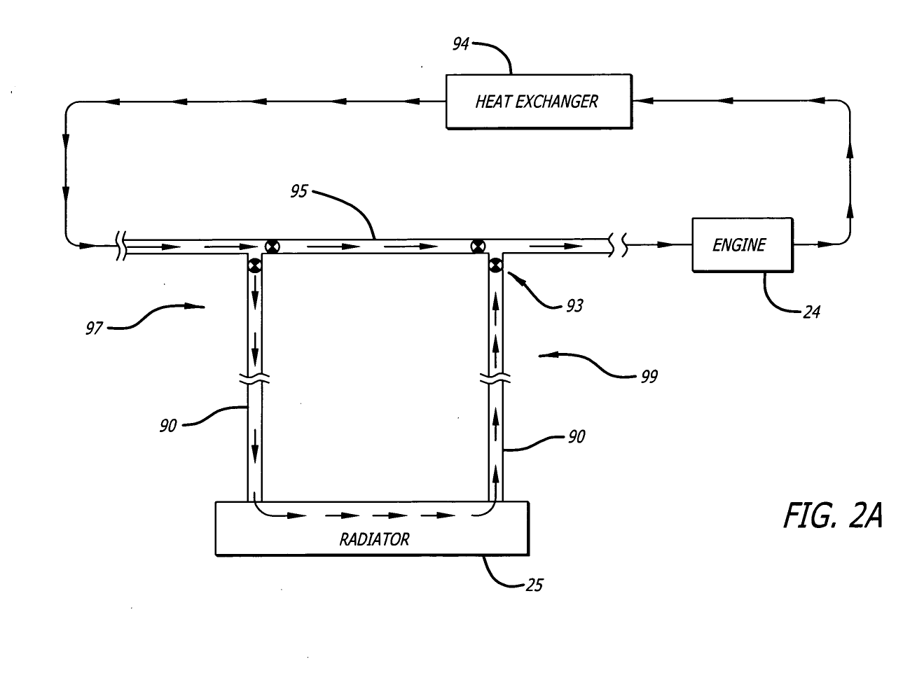

Referring to FIGS. 1 and 2, the snowmobile apparatus of the present invention includes, generally, a chassis 21 having a centrally located saddle style seat 28, forwardly disposed engine compartment 16 housing a liquid cooled engine 24 and a rearwardly disposed tail section 22 defining an upwardly facing shelf 23 under the downwardly facing undersurface 213 at the rear extremity of the seat 33 and mounting a radiator apparatus 100. The radiator apparatus 100 may include a generally rectangular radiator 25 that angles upwardly and rearwardly from the surface 23 to project parallel to the undersurface 213 and to be supported at its upper extremity by a frame housing a forced air fan 30 for drawing air through the radiator. The radiator apparatus 100 is connected with the cooling block of the engine 24 by means of coolant lines 90 incorporating a water pump 91.

As will be appreciated by those skilled in the art, personal vehicles such as snowmobiles typically include a chassis incorporating a forwardly disposed engine compartment 16 that houses an engine 24 coupled with a traction track 211 to drive the snowmobile over a snow covered terrain. The snow covered terrain may be generally hard pack, icy or in many instances a powder from several inches to several feet deep.

The snowmobile 19 typically includes a body constructed of metal, fiber glass, plastics, and/or composites and usually includes an enclosed engine compartment 16. A pair of handle bars 18 are disposed rearward of a windshield 17 intermediate the engine compartment and the seat 28. The seat in some commercial snowmobiles is constructed for double occupancy and includes on the lower side an upwardly and rearwardly sloped bottom undersurface 213 cooperating with the shelf 23 to define a wedge shaped rearwardly opening space which affords a convenient location for mounting of the radiator apparatus 100, particularly in the case of a retrofit kit.

In the preferred embodiment, the radiator apparatus is in the form of a generally rectangular radiator incorporating a conventional frame and honeycomb core and may be mounted on mounting bracketing to support it in an orientation angling upwardly and rearwardly at an angle of approximately 30° to the horizontal. In this embodiment, the rear extremity of such radiator is supported in its elevated position by means of the frame of the fan apparatus 30 so that the fan will be operative to generate a reduced pressure forwardly thereof to draw air flow in through the radiator core and expel it rearwardly to the atmosphere. The radiator may be mounted at any angle if airflow through the media is still facilitated; especially when fans are incorporated as the ducting will provide that air flows through or across the media allowing heat to be exchanged out of the engine coolant. A protective cage or cowling 39 may surround the radiator apparatus in whole or in part protecting the apparatus components from airborne debris.

In operation, it will be appreciated that the apparatus of the present invention is particularly adapted for long challenging outings over challenging terrain of varying depths and consistency. It will be recognized by those skilled in the art that the snowmobile may be operated in both areas generally covered with snow and conceivably, in environments and seasons usually uninhabited by snowmobiles, such as sand dunes and during the Summer months. One or two riders may mount the seat 28 and as the engine 24 is started and the vehicle moves forward, the engine will generate heat at a rate generally proportional to the load applied thereto. That heat will be, to some degree, contained within the engine compartment and cooling of the engine will be facilitated by coolant flowing from the radiator apparatus 100 to the coolant lines 90. The fan 30 may be thermostatically controlled or, in some instances, will be connected into the electrical system to be operative when the ignition is on. As the snowmobile is operated and heavy loads applied to the engine it will be appreciated that the rate which heat is generated by the engine will be increased. It will also be appreciated that, the radiator apparatus 100, being spaced rearwardly of the engine compartment, is essentially thermally insulated therefrom by the extensive air gap between the engine compartment and such radiator, a distance of approximately two to six feet so that there is little or no conduction of heat from the engine compartment directly to the radiator. In snowy conditions, this leaves the radiator exposed in the atmosphere at temperatures which may hover below freezing and in some instances, even below zero degrees Fahrenheit.

As the vehicle moves forward at relatively high speeds it will be appreciated that air will pass over the snowmobile body, about the sides thereof, around the passengers and on opposite sides of the seat. The air so passing on opposite sides of the vehicle tends to be drawn laterally inward from the opposite sides of the seat by somewhat of a Venturi effect to be drawn underneath the downwardly facing undersurface 213 to flow through the ducting 37 in confronting relationship with the upwardly and forwardly facing surface at the front of the radiator. Thus, air flow is induced through the radiator fins 38 and honeycomb core thereof downwardly and rearwardly, all as enhanced by the reduced pressure in the area forward and downward from the plane of the fan 30. It will be appreciated that with the weight of the radiator apparatus disposed rearwardly on the vehicle, it affords a relatively favorable counter balance relative to the engine to thus maintain a generally centrally located center of gravity for the vehicle.

It will be recognized that the cooling system described may be used as a kit to enhance an existing cooling system commercially found on liquid cooled snowmobiles to eliminate part or all of the stock cooling systems. As shown in FIG. 2A, the cooling system 99 may be teed into an existing system at a point where coolant lines 90 are accessible. As liquid flows about the cooling system, control valves 93 control an amount of liquid to bypass flow through the radiator 25. It will be appreciated that the kit configuration affords convenient disconnection of the enhanced cooling portions when conditions dictate that added cooling capacity is unnecessary by providing direct flow of cooling liquid to the engine 24 and heat exchanger 94, thus restricting overcooling and diminished performance in the vehicle. Those skilled will further appreciate that the cooling system provides an efficient arrangement for bleeding the air out of coolant lines, especially those snowmobiles configured with detachable cooling kits where bleeding of the lines is common. A bleeder valve 97 is positioned either on the highest point in the system or placed on a component that is convenient to raise. Those skilled will understand that as air bubbles are formed in the coolant lines 90, the bubbles will be lighter than the cooling liquid medium and be predisposed to traveling to the highest point in their path. The bleeder valve 97 when raised, provides a convenient means for expediting the line bleeding process by exploiting the natural movement of air bubbles towards a raised point on the system.

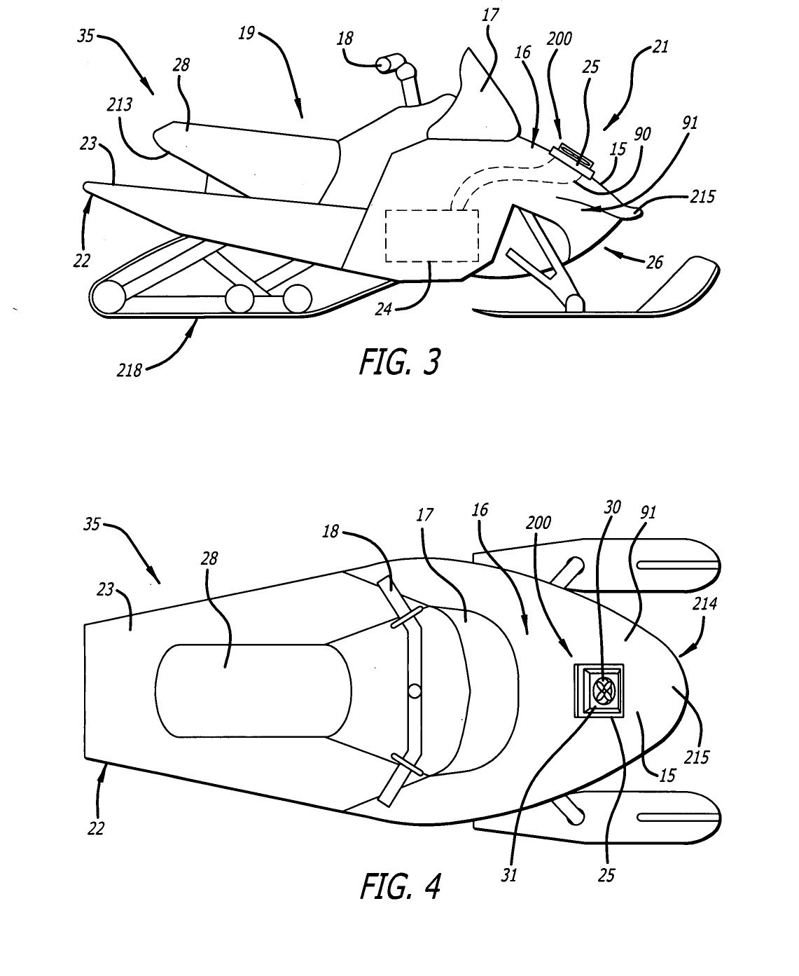

The embodiment of the snowmobile of the present invention shown in FIGS. 3 and 4 is similar to that shown in FIGS. 1 and 2 except that a radiator apparatus 200 is mounted on a mounting bracket from the hood 15 of the vehicle and is connected in fluid circuitry with the engine 24 by means of cooling lines 90 passing through the hood in to the engine compartment 16 interior with coolant once again moved through the circuit by means of a water pump 91.

Similar to the radiator apparatus I 00 shown in FIGS. 1 and 2, the radiator apparatus 200 is in the form of a generally rectangular radiator 25 incorporating a honeycomb core mounted in a conventional frame and mounted spaced from the hood 15 using bracketing supporting the radiator elevated and coextensive with the hood surface. For aesthetic purposes, some configurations may shape the radiator differently from a conventional rectangular shape. In a modification of this embodiment, a fan 30 in a conventional frame may be mounted and spaced from the radiator front face to generate a pressure drop between the fan and the radiator enhancing the draw of airflow through the radiator core and expelling a heated airflow rearwardly to the hood surface where it will dissipate into the atmosphere. In another modification, the radiator may be mounted within a recess provision incorporated into the hood with the fan communicating with the radiator via ducting.

It will be recognized that mountainous areas and elevated regions where snowmobiles are typically utilized, vehicles often travel headlong into powerful gusty winds under biting temperatures commonly digging over loose snow, demanding to some degree, a disproportionate amount of work exerted by the engine compartment components and engine 24 in the form of higher revving and thus, an increase of heat is built up in the engine compartment 16. Those of ordinary skill in the art will appreciate the advantages of mounting the radiator apparatus 200 to the hood 15 in direct confrontation with oncoming winds in a frozen environment. The operator of such a vehicle accelerates through the soft snow and headwinds out of fear of being stranded in a soft patch of terrain, causing increased wind resistance to build near the vehicle nose 215. The amassed airstream built on the nose will carry an associated wind chill effect further dropping already frozen temperatures surrounding the radiator and will confront the shielded fan 30 and radiator core 25 passing therethrough enhanced by the fan action in heat exchange relationship with the coolant flowing through the core. Similar to the first preferred embodiment, the chilled coolant will be pumped back into the engine compartment to the engine where it will be recognized that the augmented chilling of the coolant will permit an enhanced heat absorption capacity.

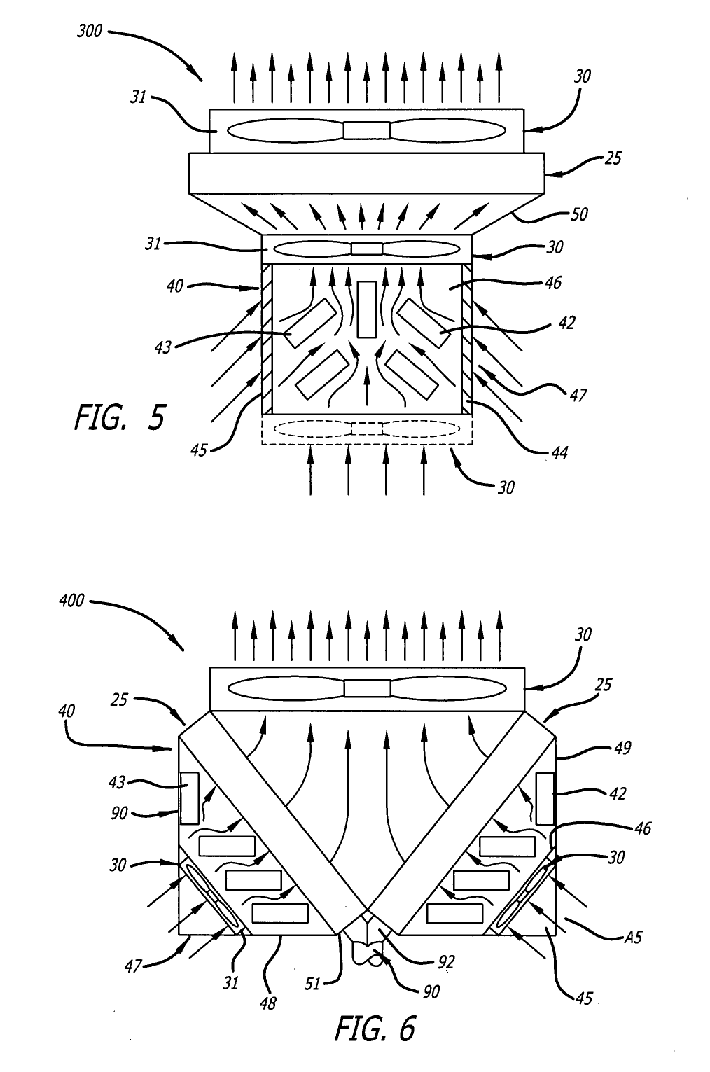

It will also be appreciated that radiators for use on the snowmobile 19 of the present invention may be constructed in kit form using conventional screws and brackets and designed in numerous configurations for optimal fitting making use of the available space and accessories on most commercial vehicles. For example, one embodiment of the present invention may use a radiator apparatus 300 configured as shown in FIG. 5. The radiator of the present invention is similar to the radiator apparatus 100 described in FIGS. 1 and 2, except that the radiator 300 is mounted upstanding and perpendicular to the snowmobile chassis 21 using bracketing and, in a third preferred embodiment, may incorporate a plenum chamber 40, ductwork 50 between the plenum chamber and a radiator core 25 and one or more fans 30 for enhanced cooling of an airflow passing therethrough. The plenum chamber is mounted on bracketing to the snowmobile chassis in linear operative alignment to the front face of the radiator core and incorporates a generally rectangular, open-ended and open-topped framing with a solid support floor 46 and sidewalls incorporating air intake channels 45 covered by grillwork 47 for obstructing foreign debris from entering the chamber and the framing defining a chamber cavity therein for placement of multiple vessels 42 for holding a heat absorptive substance in each. In one embodiment, the vessels incorporate open tops for receipt of the substance and are arranged in an upstanding chevron pattern with vessel ends in air flow cooperation with the plenum chamber open ends and air intake channels. A fan 30, similar to the one described in FIGS. 1 and 2, may be mounted to bracketing on either open end of the plenum chamber in a generally upstanding and planar relation to the radiator core face. Optionally, a second fan may also be mounted planar to and in connection with the rear face of the radiator core.

It will be appreciated that the configuration of radiator 300 facilitates mounting to various exposed surfaces on the chassis of the present invention and operates similar in cooperation to the operation of the vehicle as described in FIGS. 1 and 2 except that the various radiator features are arranged in a generally linear formation exploiting natural environmental characteristics in the cooling of the radiator. The embodiment of the present invention may use a commercially sold vehicle and incorporate a radiator 300 fit into the wedge-shaped open area between the bottom surface 213 of the seat 28 and the shelf 22 in a similar manner to the radiator 100 shown in FIGS. 1 and 2. Just as in FIGS. 1 and 2, the present invention will incorporate coolant lines 90 connected to the radiator in fluid circuitry with an engine mounted within the engine compartment and separated from the radiator by the chassis and seat.

It operation, as the vehicle is driven forward and as air passes around the vehicle sides, once again, the air flow will be drawn laterally inward around and beneath the seat 28 by a Venturi effect. It will be appreciated that an accelerating vehicle generates a substantial air flow about the vehicle sufficient to enter the radiator 300 front open end and air intake ducts of the plenum chamber 40 continuing toward the core 25 in guided fashion by the air intake ducts 45, ductwork 44 and vessels 42, all of whose guided airflow may be enhanced by low pressure areas created by operation of the fans 30. It will be further appreciated that the present invention is particularly suitable for high speed and long distance excursions on days where the temperature is relatively climbing. Aside from enhancing the heat transfer rate by virtue of increasing airflow, those of ordinary skill in the art will recognize that the present invention will at times be operated in less than freezing winds and over prolonged distances where heat generation may be disproportional to the load exerted on the engine. It will be recognized that the air flowing around the vehicle and into the radiator will benefit from augmented cooling as the airflow passes through the plenum chamber guided and in heat exchange relation to the heat absorptive vessels contained therein before confronting and flowing through the radiator core. Most of the incoming airflow will contact multiple vessel surfaces increasing heat absorption capacity prior to contacting the radiator core. It will be appreciated then that operating the present invention in a relatively warmer airstream, the vehicle will benefit from the enhanced heat exchange capacity of the radiator apparatus. It will be further appreciated that warmer days are often associated with slushier snow trails and will, in some cases, bias the vehicle nose downward creating undesirable drag and that mounting the radiator to the vehicle rear will, similar to the embodiment described in FIGS. 1 and 2, behave as a counterbalance to the forwardly disposed engine assisting in lifting the nose upward.

Similar to the radiator 300, another embodiment of the present invention may instead use a radiator apparatus 400 configuration such as the one shown in FIG. 6 exploiting the same or similar available spaces preexisting on most commercial snowmobile chassis and the benefits of operation through an airstream except that radiator 400 incorporates instead a dual core design. In such an embodiment, the radiator apparatus incorporates a generally rectangular plenum chamber 40 defined by a solid support floor 46, open rear and top walls, solid front 48 and side walls 49 with air intake ducts 45 formed on the front corner intersections of the sides and front wall and an opening 51 formed intermediately along the front wall. A pair of cores 25 are mounted upstanding and diverging from mutual contact at the plenum front wall opening and mounted in attachment to the rear wall corners defining a faceted intersection of the rear and side walls with respective cores mounted approximately 45° from the front wall horizontal and the core rear faces defining a V-shaped cavity relative to the rear wall. Mounted between respective radiator cores and respective chamber air intake ducts are heat absorptive substance carrying vessels 42 arranged in airflow guiding relationship from the intake ducts to respective cores.

In a fourth preferred embodiment, fans 30 are mounted planar to the respective cores angled to the front wall within the chamber in intersecting attachment to the front and side walls between the vessels and air intake ducts. Another fan may also be mounted on bracketing planar and in attachment to the plenum rear wall for generating a pressure differential between the cavity and rear of the radiator. It will be appreciated that although two cores are used in this embodiment, the radiator apparatus remains adaptable for mounting within compact pre-existing spaces using conventional bracketing and fastener means.

It will also be appreciated that the radiator apparatus 400 is also particularly suitable for easy installation on snowmobiles that engage in challenging travels through both compact and soft snow terrains. Similar to radiators 100 and 300, the radiator 400 may be placed on existing platforms to the rear of the snowmobile. Much like previous embodiments, as the vehicle accelerates through heavy snow or adverse conditions, heat generation may to some degree become disproportional to the heat transfer away from the vehicle. It will be appreciated by those skilled in the art that as the vehicle moves and airflow around the vehicle is drawn in laterally toward the radiator and the airflow enhanced by the low pressure areas within and behind the plenum created by the fans, cooling airflow is thus induced confronting approximately twice as much radiator core area. Coolant pumped from the engine through the coolant lines will connect to the respective radiator cores into separate lines through coolant intake valves 92 carrying twice the heated coolant capacity through the cores subject to the enhanced cooling effect from respective plenum chamber sections and thus carrying back to the engine an enhanced cooled liquid.

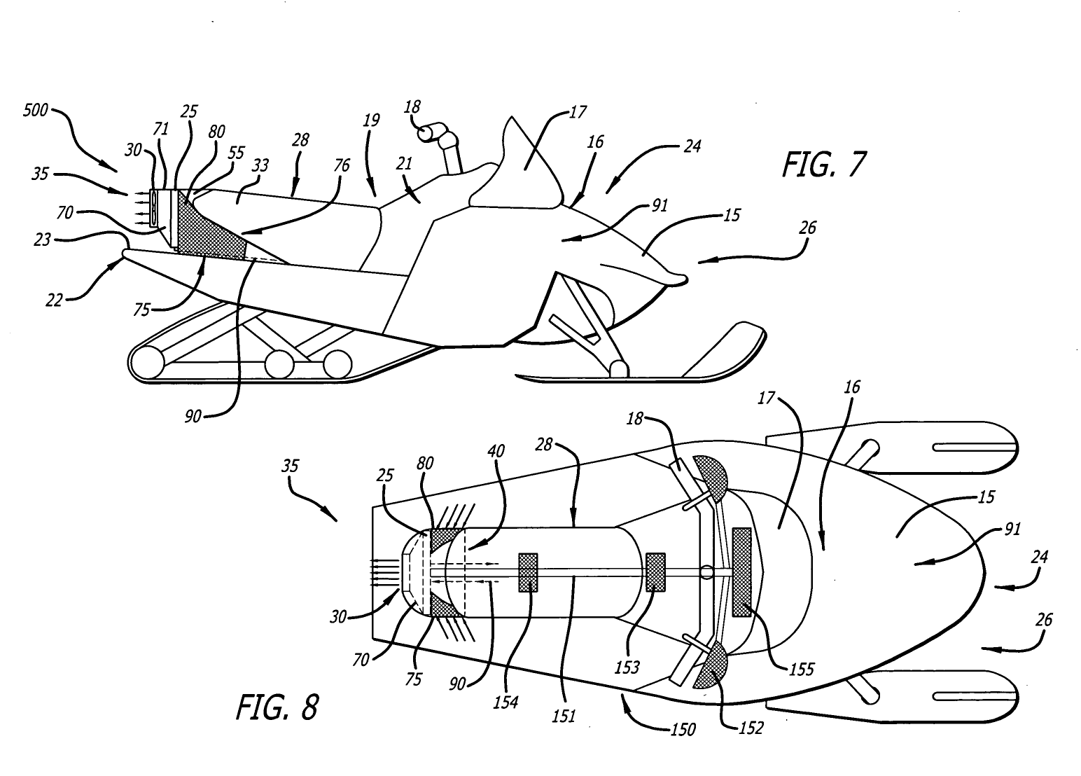

It will further be appreciated that operators and consumers of such snowmobiles seek efficient aerodynamics and pleasing aesthetics in the selection of their vehicles. The embodiment of the snowmobile 19 of the present invention shown in FIGS. 7 and 8 is similar to that shown in FIGS. 1 and 2 except that the radiator 500 is incorporated within the open wedged section mounted within a generally solid casing 55 mounted flush against the shelf surface 23 on the casing bottom portion and projecting from the tail end 33 of the seat 28 rearwardly and incorporating laterally downward side walls in engagement with the shelf surface to form a generally tubular shape incorporating duct work 75 along the side walls, a radiator core 25 mounted to the casing rear extremity, and grillwork 80. The ductwork 75 includes air intake channels 76, incorporated along the side walls of the casing protected by the grillwork 80. The radiator core 25 is in a generally upstanding position perpendicular to the shelf surface of the snowmobile chassis mounted on bracketing in operative airflow connection to the ductwork 75. It will be recognized that the angle and shape of the radiator will be dictated by the size and shape of the existing space on the snowmobile. Once again, coolant lines 90 run through the snowmobile chassis 21 in fluid circuitry with the engine 24 disposed within the forward engine compartment 16.

In a fifth preferred embodiment, the radiator 500 includes a fan 30 mounted on bracketing planar and rearward of the radiator core 25 and spaced there from in operative connection by ductwork 70 for generation of a pressure drop system to the rear of the core.

It will be appreciated that similar to the embodiment showed FIGS. in 1 and 2, the embodiment of the present invention is conveniently adaptable for use over long excursions and adverse conditions that cause significant drag on the vehicle with the use of the radiator 500 as described. It will be appreciated that the snowmobile of the present environment will operate in much the same way traveling forward and confronting an airflow that will flow over the smooth contours of the nose and the rounded forward portion of the snowmobile and will continue flowing toward the rear of the vehicle hugging the relatively smooth contours of the seat and the radiator casing 55 and in confronting the sudden openings on the casing side walls and ductwork 75, a portion of the air will be drawn laterally into the air intake channels and grillwork 80 by a Venturi effect, as illustrated in FIG. 8. The airflow may continue towards the face of the radiator core passively or all such airflow may be enhanced by the low pressure area generated from the fan 30 drawing airflow in towards the radiator and therethrough ultimately expelling out the rear of the radiator away from the snowmobile and the rider. It will be further appreciated, similar to previous embodiments, that mounting the radiator rearward of the seat and in separation from the engine exposes the radiator core to operation in freezing temperatures enhancing the chilling process and heat exchange efficiency of coolant flowing through the radiator therein and thus, exploiting the conveniently accessible cold ambience the vehicle travels through. It will further be appreciated that the radiator is mounted unobtrusively in an underutilized section of the snowmobile distant from both the engine and the operator where heated airflow is dispatched to the rear of the vehicle into the atmosphere.

Those skilled will also recognize that the fans may reverse airflow so that heated air from the radiator may be directed toward the forward section of the vehicle via vent ducting 151 consisting of rigid ducts and flexible hosing and will find the venting system 150 particularly useful for providing a controlled heat to either a rider or to selected vehicle portions. As heat is exchanged from the radiator to ambient air, fans pull heated air into the vent ducting through the vehicle chassis where the driver or passenger are warmed as air controllably exits through a driver seat vent 153 or passenger seat vent 154. Those skilled will also recognize that one common problem faced by riders in frigid, snowy environments are numbness in the hands caused by prolonged gripping of a vibrating handlebar in freezing temperatures and that the venting system 150 incorporating a hand guard vent 152 in heated airflow connection with the vent ducting 151 leading to the handlebars 18 provides a controlled heat to those extremities in a comfortable regulated fashion. Likewise, it will be appreciated that the vent system may also pull heated air towards the windshield 17 affording an efficient and reliable defrosting mechanism by expelling the heated air toward a frosted windshield through the windshield vent 155.

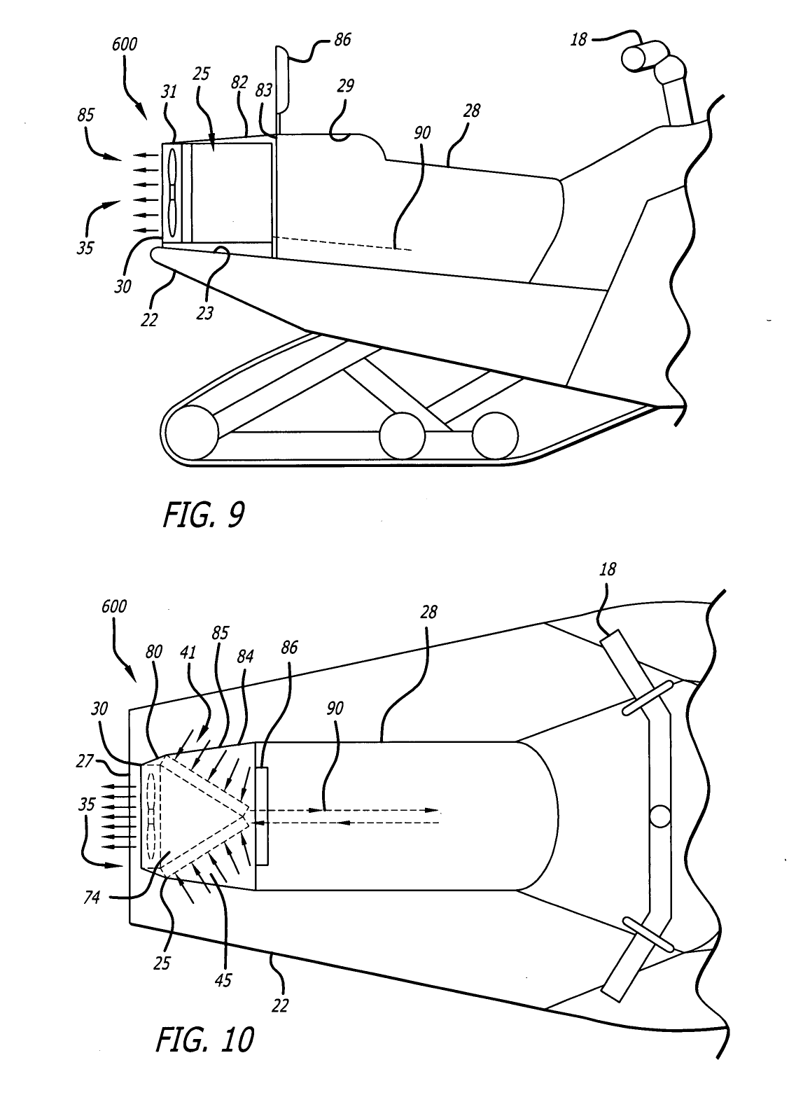

It will be recognized that some enthusiasts are often intent on traveling over long distances transporting vital supplies or creature comforts and will purchase vehicles with preexisting accessory mounts such as utility racks or saddle bag mounts. The embodiment of the vehicle of the present invention shown in FIGS. 9 in 10 is similar to that shown in FIGS. 1 and 2 except that in such commercial vehicles the seat is mounted centrally disposed on the chassis with the seat bottom surface constructed flat and mounted flush against the surface 23 and terminates upwardly and flat at its rear incorporating a seat frame 83 including a generally upright backrest 86. Similar to the seats shown in FIGS. 1 and 2, the seat 28 may accommodate one or two passengers and is constructed generally cylindrical and partitioned by a lower front section and a raised rear section 29 with the top surface of the seat generally rounded along the top and side surfaces. These vehicles will be recognized as suitable for traveling long distances and as such incorporate a utility rack/luggage rack 85 on the shelf section 22 mounted to the rear of the backrest atop the surface 23. The shelf section is similar to the one shown in FIGS. 1 and 2 and incorporates a chassis tail section with a flat top surface and an upwardly and rearwardly intersecting bottom surface defining a rear edge 27 to form a generally wedge-shaped shelf, which will be recognized as forming a convenient platform and mounting location for a utility rack and similarly conveniently suited for mounting the radiator within the rack.

The embodiment of the present invention also incorporates a radiator 600 encased in a generally rhomboidal casing 82 with the side walls converging slightly inward towards the radiator rear wall, a covered roof and sealed front surface mounted in abutment with the seat rear wall and frame 83 and with open rear and side walls. The generally rhomboidal casing in connection with the cylindrical form of the seat form an overall smooth chassis rear and inward converging tail. Two radiator cores 25 similar to the mounting shown in FIG. 6 are mounted within the casing generally upstanding and in contact at one end with each other and diverge rearwardly away from the seat defining a V-shaped cavity 74 between the two radiator rear face walls. The casing includes air intakes 45 on both side walls covered by grillwork 80. A fan 30 is mounted generally upstanding and planar to the seat rear wall and in airflow operative connection to the divergent cores forming a triangular configuration therein for creation of a low pressure area within the triangular cavity.

It will be appreciated by those of ordinary skill in the art that vehicles with pre-existing convenience mounts such as luggage racks and saddle bag mounts afford a compact and convenient location for mounting adaptable radiator kits such as the present invention. The utility rack 85 provides readily equipable and mountable framing for mounting a kit incorporating the radiator 600 using conventional bolts and mounting brackets. A backrest 86 and rear seat wall along with the flat mounting surface afford a sturdy and stable mounting surface for placing the radiator 600 upon. Similar to the embodiment described in FIGS. 8 and 9, as the vehicle moves forward it will be recognized that the air will hug the smooth shape of the snowmobile chassis. As the air passes around a smooth front and along the smooth rounded intermediate chassis section, the air will hug the sides of the chassis and the rhomboidal casing and air on opposing sides of the converging tail will converge inward and once again will be drawn laterally inward towards the casing side walls because of the sudden openings of the ductwork in a Venturi effect. Upon flowing through the ductwork, the airstream will flow into direct confronting heat exchange relationship with the radiator cores and such flow will be enhanced by the pressure drop area generated between the radiator cores by the fan 30. As will be recognized, such vehicles are typically used in long distance excursions and will benefit from the enhanced cooling capabilities of the rear mounted dual core radiator. Cooling of the engine will function similar to the operation of the snowmobile shown in FIGS. 1 and 2, except that as coolant flows from the engine to the coolant lines 90, the coolant is split into two lines as it reaches the two cores with respective cores receiving a proportional amount of coolant. The vehicle of the present invention may be traveling in a frozen environment over long distances generating an appreciable amount of heat in the engine compartment which will be transferred out of the engine compartment and rearwardly to the chassis and the radiator encountering at least one of the two cores. It will also be recognized that operation in some environments will include traveling amongst airborne debris and that much of the debris will encounter the front face of the vehicle effectively shielding the radiator from most of any obstruction. It will be further recognized that if debris should enter and obstruct one of the cores, the second core will be understood to operate independently and effectively of the other core.

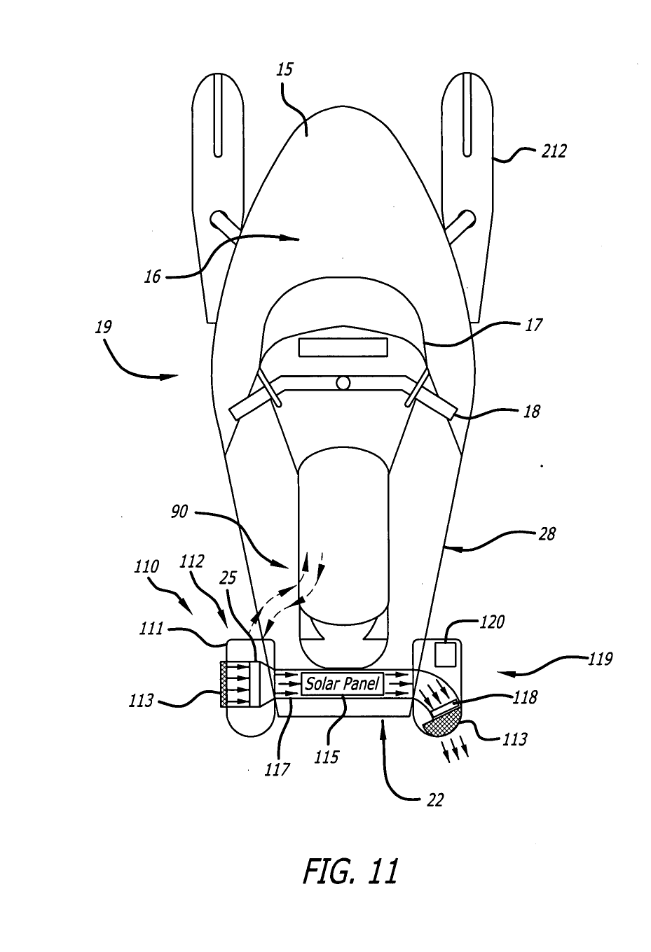

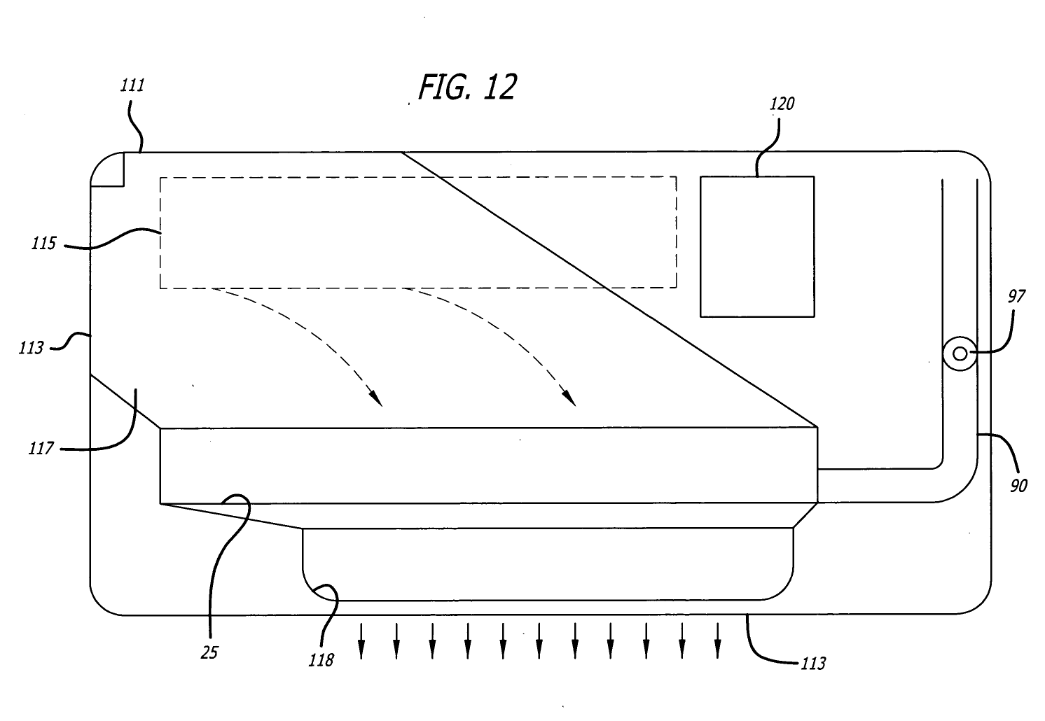

The embodiment shown in FIGS. 11 and 12 is similar to the embodiment shown in FIGS. 9 and 10, except that the radiator is equipped within saddlebags 111 on saddlebag mount 110. As will be understood by those skilled in the art, the convenience and portability of the radiator apparatus 700 is suited for efficiently exploiting the spatial confines available of either one or more saddlebags. As depicted in FIG. 11, one embodiment of the radiator apparatus is operatively split between saddlebags 111 straddling either side of the tail section 22. The saddlebags are preferably made from a lightweight, sturdy and flexible material such as fabric, padding, Texans or polyethlene. Radiator 25 is mounted generally upstanding and planar to the snowmobile chassis within a first enclosed saddlebag 111 by saddlebag mounting fixtures 112. The first saddlebag incorporates a meshed opening 113 in airflow connection to the radiator 25 by ducting 117 available on either side of the radiator. The ducting 117 continues in operative fashion connecting an airflow passage between the first saddlebag to a second enclosed saddlebag housing a power source 1209 and fan 118 mounted adjacent a second mesh opening 113. In some instances, a solar panel 115 may be mounted on the tail section 22 or mounted directly to an environmentally exposed surface of the bag for powering the power source 120 for fans 118. It will also be recognized that the radiator apparatus 700 may be mounted and self-contained within a single bag enclosure (FIG. 12) that is similar to the embodiment shown in FIG. 11 except that ambient air is pulled from one meshed opening 113 on one side of the bag through ducting 117 and drawn through the radiator 25 by a fan 118 and expelled out a second opening 113. The solar panel 115 is mounted on top of the saddlebag in electrical connection with a power source 120 housed within the bag. Flexible coolant lines 90 lead to and from the radiator 25 passing through the bag lining in circulatory connection with the engine and may include an air bleeder valve 97.

It will be appreciated that the saddle bag mounted radiator system conveniently provides a detachable solution for augmented cooling capacity while exploiting pre-manufactured elements of the vehicle rear. It will be recognized that the radiator apparatus 700 may be pre-manufactured and available within a saddle bag enclosure kit quickly connectable for attaching to the vehicle when the driver recognizes he or she is traveling through changing climates necessitating changing cooling requirements. In operation, for example, the driver may store the bag enclosed radiator system 700 under the seat 28 when traversing over snowy and adequate cooling conditions. As the driver continues and encounters warmer regions or increased work exertion from the terrain, the driver may pull over, remove the stored radiator apparatus 700 from the seat compartment and situate it to the saddlebag mount fixture 112, connect the coolant lines 90 to the engine mount, bleed any air out of the lines as necessary, turn on fans 118, hop back on his snowmobile and drive onward allowing the ambient air to travel once again around the vehicle body until it encounters the saddle bag side where the fans draw air inward through the radiator and out the bag rear away from the vehicle. Should the power source 120 run low, the saddlebag system may be left mounted allowing the solar panel 115 to remain exposed to ambient solar energy re-powering the power source. It will be further appreciated that bleeding the air out of coolant lines may be a laborious and time consuming task when connecting lines to a system and that the saddle bag radiator apparatus is particularly efficient for bleeding the air out. The air bleeder valve 97 is located at a high point in the system or can be easily raised when contained in the removable saddlebag where air bubbles will want to rise to that high point.

From the foregoing it will be apparent that a snowmobile incorporating a radiator mounted externally and distant from the engine compartment provides an improved engine cooling system and a safer vehicle. Additionally, an economically feasible and conveniently mountable radiator kit has been presented for mounting on commercially sold vehicles on the market.

I claim:

1. A fluid cooled snowmobile comprising:
a longitudinal chassis including an internal combustion engine housed in a forwardly disposed engine compartment and a centrally disposed seating apparatus;
a radiator disposed outside the compartment;
a radiator mount on the chassis for mounting the radiator;
coolant lines connected between the radiator and internal combustion engine for circulating a coolant from the radiator to the engine; and
a fluid pump for pumping the coolant through the coolant lines.

2. The snowmobile of claim 1, including:
a rear section of the chassis; and
the radiator mounted to the rear section.

3. The snowmobile of claim 2, wherein:
the rear section includes a luggage rack and the radiator mounted to the luggage rack.

4. The snowmobile of claim 2, wherein:
the mount includes saddle bags mounted to the rear section of the chassis.

5. The snowmobile of claim 1, wherein:
the radiator is mounted rearwardly of the seat.

6. The snowmobile of claim 1, wherein:
a fan mounted adjacent the radiator for forcing air over the radiator and including an electric motor connected with an electrical system of the snowmobile.

7. The snowmobile of claim 1, including:
fans on opposite sides of the radiator for forcing air onto the radiator from one side and drawing air from the other side.

8. The snowmobile of claim 1, including:
a plenum chamber disposed in heat exchange relationship with the radiator for receipt of an energy absorptive element.

9. The snowmobile of claim 1, wherein:
the radiator is in the form of at least two radiator cores projecting at an acute angle to one another.

10. The snowmobile of claim 9, including:
plenum chambers on the respective one sides of the radiator cores for receipt of heat absorptive elements;
forced air fans for forcing air to the respective plenum chambers over the heat absorptive elements in the plenum chamber and in heat exchange relationship with the respective radiator cores; and
a radiator fan on the side of the radiator cores opposite the respective one side for drawing air from the respective radiator cores.

11. The snowmobile of claim 1, wherein:
the radiator mount is constructed to mount the radiator in a vertical orientation adjacent the rear of the seating apparatus; and wherein
the snowmobile includes air ducting beneath the seating apparatus leading from laterally opening inlets to a front of the radiator.

12. The snowmobile of claim 11, including:
air grills covering the inlets.

13. The snowmobile of claim 11, including:
a fan mounted adjacent the radiator for flowing ambient air in heat exchange relationship therewith.

14. The snowmobile of claim 1, wherein:
the radiator is planar and mounted at an angle sloping upwardly and rearwardly at the rear of the seating apparatus and the snowmobile includes a forced air fan disposed adjacent the radiator for forcing air through the radiator.

15. A snowmobile cooling conversion kit for use with a snowmobile having a cooling jacketed internal combustion engine disposed forwardly on the chassis of the vehicle and comprising:
a radiator including a radiator core for disposition rearwardly on the chassis;
a mount for mounting the radiator rearwardly on the chassis;
an electric fan to be mounted in a flow stream to, when operated, flow air in heat exchange relationship with the radiator;
coolant lines for connecting the core of the radiator with the cooling jacket.

16. A snowmobile including an electrical system and comprising:
a chassis having a forwardly disposed engine compartment;
an internal combustion engine having a coolant jacket thereon mounted within the engine compartment;
a passenger seat medially disposed on the chassis;
a radiator;
a radiator mount for mounting the radiator outside the engine compartment on the chassis; and
the radiator is mounted relative to an incoming airstream in heat exchange relationship with the radiator.

17. The snowmobile of claim 16, wherein:
the chassis includes a hood covering the engine compartment; and
the radiator mount mounted to the hood.

18. The snowmobile of claim 16, including:
an electric fan mounted adjacent the radiator for flowing air in heat exchange relationship with the radiator; and
an electric motor for driving the fan and connected with the electrical system of the snowmobile.

19. The snowmobile of claim 16, including:
a plenum chamber mounted adjacent to the radiator and disposed within the airstream in heat exchange relationship with the radiator.
